(19) United States
(12) Patent Application Publication
(10) Pub. No.: US 2025/0272512 A1
(43) Pub. Date: Aug. 28, 2025

(54) Method of digital document review using factor graph document databases

(71) Applicant: Verses AI, Inc., New Westminster (CA)

(72) Inventors: Timothy Edward Bellay, Dallas, TX (US); Sara Summers, Austin, TX (US); Jason Gregory Fox, Dallas, TX (US)

(21) Appl. No.: 19/064,659

(22) Filed: Feb. 26, 2025

Related U.S. Application Data
(60) Provisional application No. 63/558,504, filed on Feb. 27, 2024.

(51) Int. Cl. G06F 40/40; G06F 16/93; G06F 40/284; G06F 40/30

(52) U.S. Cl. CPC G06F 40/40; G06F 16/93; G06F 40/284; G06F 40/30

(57) ABSTRACT

A method of digital document review using factor graph document databases comprising an extract method and a summarise method, wherein the extract method uses a Large Language Model (LLM) to decompose into variables and elements a document or series of documents and to identify new terms semantically associated with the description of the interest of the desired audience for the document review process, and representing the variables and elements in a factor graph document database, and wherein the summarise method includes indexing the factor graph document database based on terms of interest to the audience of the review, and inferring which of the new variables and elements are relevant to the audience, and reconstructing a human interpretable document out of the variables and elements inferred in the factor graph document database.

### FIELD OF INVENTION

This invention concerns the field of digital document review.

### BACKGROUND

Document review is the process whereby text, audio, video, or any source documents are reviewed in order to extract the information contained in the documents and summarise that information in a way relevant to an audience. Document review involves: (i) extracting relevant information from source documents, (ii) storing the extracted information in a database, and (iii) performing operations over the stored information to generate a summary relevant to an audience. Digital document review refers to the digitalization of the three steps involved in document review.

Document review, digital or analogue, is a necessary process in any organization that involves multiple actors producing documentation (e.g., corporate, governmental, legal, healthcare, military, educational, etc.), and that includes people that need to efficiently access that information (e.g., CEO office, doctors, lawyers, etc.). Efficient document review is especially needed in cases where the institution produces a variety of expert documents (i.e., reports, code, etc.) that cannot be interpreted by any lay audience.

Digital document review is used in corporations, for instance, by the CEO office to access concise and relevant information about the current state of a product line or information about the development of a technology by the actors of the research and development team, or information about staff competencies available based on the current payroll, and thereby information about what kind of workers ought to be hired next.

To be relevant to an audience (e.g., to CEO office), summaries of document reviews must be actionable, that is, summaries must contain information that is specific to what the audience needs to accomplish with the summary (i.e., insights, such as business impacts, investment opportunities).

Current processes for digital document reviews are limited in that obtaining insights (i.e., actionable information) often requires the audience itself to either carry the review (e.g., the CEO office), or it requires the audience to be heavily involved in the process to make sure that the information summaries obtained match the audience's needs (e.g., the CEO being involved in thorough meetings or direct order as to what the summary should contain).

### SUMMARY OF THE INVENTION

The claimed method of improving digital document review using factor graph document databases improves on existing processes of digital document review by using Large Language Models (LLM)—defined below—to automatically extract actionable information from a series of documents whose components can be decomposed into variables and elements taking numeral, boolean or string values, and by using a factor graph document database—defined below—to store the extracted information and augment the capability of the review process with inference about existing related information in the factor graph document database, thereby automatically providing actionable information summaries.

### BRIEF DESCRIPTION OF THE DRAWINGS

FIG. 1 is a depiction of the structure of a simple prior art graph database as known in the art;

FIG. 2 is a depiction of the structure of a computation graph database as known in the art;

FIG. 3 is a depiction of the structure of a factor graph document database treated as a computation graph database, as known in the art;

FIG. 4 illustrates a flowchart of one embodiment of the invention, and

FIG. 5 illustrates an example of a factor graph document database that can infer the variables for a summary.

### DEFINITIONS

### Large Language Model

A Large Language Model (LLM) is a model part of the class of computational models known as foundation models. Foundation models are computational models that are pre-trained on a large amount of data. LLMs are foundation models that have been trained on text data, specifically (e.g., text files found online). By analogy, an LLM is like a person who would have read and encoded the information coming from a vast amount of texts (e.g., has read many books, websites, etc.) and that could combine the knowledge that she has acquired to respond to various queries (e.g., “what is the color of the sky?”). An LLM is built out of the combination of three elements: (i) text data, (ii) a computational architecture, and (iii) a training process. Depending on the LLM, the computational architecture will differ. For instance, for well-known LLMs such as GPT-3, the computational architecture used is a neural network that has a transformer architecture. Transformer architectures perform 1-to-many string comparisons (e.g., comparing a sentence to all similar sentences, or more precisely “tokens”) to then generate new sentences that are informed by the syntax of the already known sentences. The process starts with an encoding step that involves: (i) transforming the natural language into token embeddings, which are numerical representations of the words (i.e., strings of numbers), (ii) estimating the normal position of the words and sentences, with respect to one another, which is made possible by the conversion of the words into their numerical equivalent (e.g., “The” comes before “sky”), (iii) tracking the normal relationship between the words turned into numerical representations using a process called self-attention (e.g., words like “blue” relate to nouns like “sky”, and not articles like “the” when they are positioned after names like “sky”). The encoded sentences can then be used to perform various mathematical operations to further compare the sentences, find similar sentences, predict what words could be used to complete the sentences, find sentences that respond to other sentences, etc. With respect to how LLMs are used in general, and in this invention, text inputs known as “prompts” are used as inputs to the LLM to generate text output that functions as responses to the prompt. Prompts can be questions (e.g., what is the color of the sky?) or imperative statements (e.g., write a computer code that can be implemented to generate sky in a game engine). Prompts are structured in a way that can elicit the desired response--similar to how one would structure a question posed to humans so as to elicit a certain response. The activity of engineering a prompt to elicit the desired response is called “prompt engineering”. In summary, LLMs are used as tools for responding to natural language queries, just like calculators may be used for responding to a query in mathematical language (e.g., “what is 2+2?”). Prompt engineering is the activity of asking the right question to an LLM (e.g., asking “what is 2+2” when looking for an addition instead of asking “what is 2×2”). An LLM is a foundation model trained on text data that takes as input an engineered text “prompt”, and processes that prompt to generate an output, which is the response that corresponds to the prompt. This invention is not limited to the use of LLMs based on transformer neural networks, but includes LLMs in general. The claimed method covers any computer system able to receive a prompt-like input and generate the appropriate response to the prompt.

### Factor Graph Document Database

Databases are queryable data stores. The three common classes of databases are relational databases, graph databases, and vector databases. Compared to relational and vector databases, graph databases store data in a way that allows for querying by looking at parent-child relationships between the stored entities (e.g., “give me the child entities to the Steve entity”). Graph databases can represent entities in the world and the relationships between them. Entities are any physical or conceptual “thing” that has meaning in the real world (e.g., a robot, a sofa, a waypoint in space that refers to a location where one can go, a specification of an activity, etc.). Relationships between entities are expressed as edges that connect source nodes (e.g., the parent or cause nodes) and the destination nodes (e.g., the children or the consequence node), and that can give cause-consequence, or parent-child information.

A vector graph document database is a queryable data store. Vector graph document databases are databases whose structure allows for mix queries combining relational, graph, and vector databases type queries (e.g., “give me the products whose prices are greater than 5 dollars and that are sold by the company X, and whose description best matches that of sunglasses”).

A computation graph database is a graph database for a computation graph. The computation graph is a directed graph, which includes source and destination nodes that represent variables, and further includes edges representing transformations in the value of a destination node that can occur when an update happens to a connected source node. The terms “entity”, “node” and “variable” are used interchangeably. A computation graph database is thus a graph database that can be used to perform mathematical operations over the stored entities.

A factor graph is a type of probabilistic graphical model that can be used to perform inferences over the entities represented by the nodes in the graph. A factor graph consists of two types of nodes: (i) factor nodes, which represent factors or functions that relate multiple variables together (e.g., the function that multiplies the elements x1, x2, x3 . . . of a variable X with the elements y1, y2, y3 . . . of a variable Y), (ii) and variable nodes, which represent the variables in the model. For the factor graphs used in this invention, we use a bipartite graph representation and partition the graph into factor nodes and variable nodes. The factor nodes are connected to the variable nodes that they depend on, and the graph structure reflects the conditional dependencies between the variables. Variable nodes are denoted by circles and correspond to variables over which the inference algorithm applies. Variable nodes are entities of the vector graph document database. Factor nodes are denoted by squares and denote the relation between variables, or entities.

A factor graph document database is a type of computation graph database that uses a factor graph to implement a vector graph document database over which factor graph operations such as message passing can be performed. Factor graph operations allow the inference of values of any desired nodes in the vector graph document database. Thus, factor graph document databases are computation graph databases structured as factor graphs, and that are able to perform factor graph operations such as message passing.

In one embodiment of this invention, the code for the claimed method of digital document review using factor graph document databases is implemented as a class in the Python programming language and is composed of an extract method that extracts relevant information from source documents using a LLM, and that stores the extracted information in a factor graph document database, and a summarise method that performs operations over the stored information, based on the user audience specification, to generate a summary relevant to a specific audience.

### DETAILED DESCRIPTION

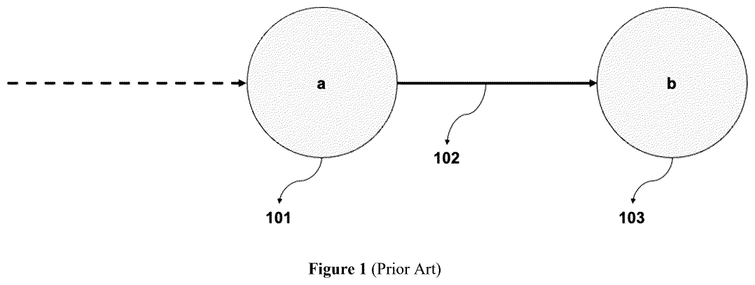

FIG. 1 illustrates the structure of a simple prior art graph database with two nodes: source node 101, and destination node 103, related to each other by an edge 102. A graph database gives parent-child information about the entities (which are defined by the nodes) contained in the database. The graph database represents parent-child information by using edge 102 relating the source entity 101 and the destination entity 103.

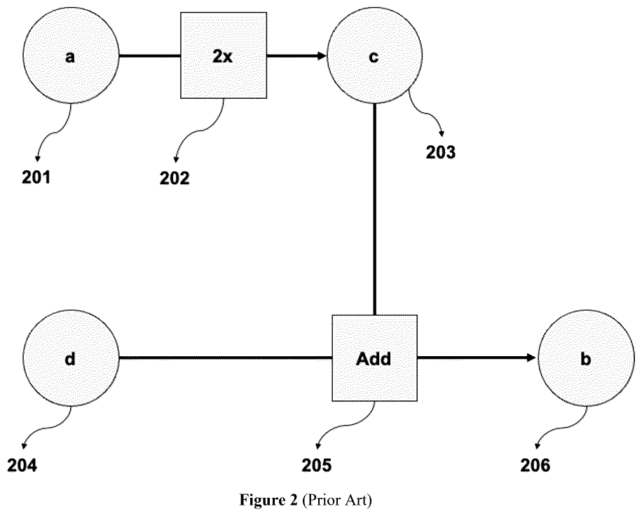

FIG. 2 illustrates the structure of a prior art computation graph database performing a mathematical operation “b=2a+d” over the source node “a” and a destination node “b”. The update rule is represented as a mathematical operation whose description is encoded in the graph database (e.g., operations represented as squares in FIGS. 2 operating on factor nodes and intermediary nodes) and operated through a call to a programming language. In FIG. 2, this is defined by source node a (201) being subjected to a multiplication operation 202 to define interim node 203. The mathematical is represented by the edges. Node d (204) is added by “Add” operation 205 to the value of interim node 203 to define destination node b (206). The function of a computation graph database is to update a destination node (e.g., b) when a change in a source node (e.g., a) happens. When a change in entity a (201) is observed, the value of the entity b (206) is updated. The update rule is operated through two transforms, which are transform 202, which calculates two times the value of a (2a) to define variable c 203, and transform 205, which adds variable c to variable d 204 to update variable b 206. This operation thus requires an intermediary entity c 203 that is constructed for the purposes of evaluating the expression operated by the transform in 205.

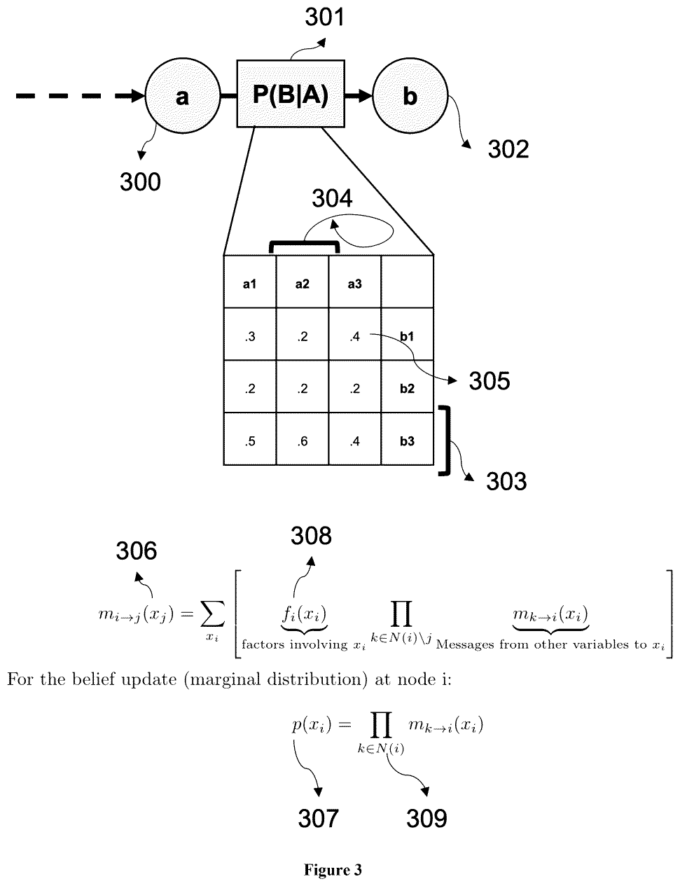

FIG. 3 shows the structure of a factor graph document database treated as a computation graph database. As a type of computation graph database, a factor graph database can perform operations such as message passing to update the variables stored in the database, based on the edge presenting the mathematical or logical relation between the variables represented by the nodes. The factor graph relates variables by means of nodes, in this case, a source node a (300) and a destination node b (302), and their relating factor encoding information 301 about the conditional probability of elements of the variable b relating to elements of the variable a. The probabilities are presented as mappings in matrices (or in tensors). 304 indicates that the column of the matrix corresponds to a probability distribution (i.e., must sum to 1, e.g., 0.2+0.2+0.6). Each cell encodes a probabilistic mapping between the variable represented by the column (e.g., elements of variable a, such as a1, a2, a3) and the variable represented by the rows (e.g., elements of the variable b such as b1, b2, b3). Reference numeral 303 indicates the rows that represent the observed variable, or the children of an entity. Reference numeral 305 indicates that the probability of b1 being related to a3 is 40% (0.4). The mathematical operation performed by the factor graph document database is an inference algorithm represented in the equation (306-309). The factor graph document database infers variables and elements automatically using programming language upon the receipt of an element belonging to a destination node, the destination nodes functioning as inputs to a factor graph document database (e.g., when receiving “b2” as an input, inferring automatically what “A” element relates to it). The algorithm is a message-passing algorithm that computes the message from node i (e.g., a) to node j (e.g., b). The message is defined as the summation of the product of the factor at the node of interest and of the messages coming from other variable nodes, over all possible values of the entity i as encoded by the link 306, N (i) referring to the set of neighboring nodes. 307 is the marginal probability of node i, 308 is the factor associated with node i, and 309 is the set of neighbors of node i. The inference method of the present invention uses a factor graph document database. In one implementation, the factor graph document database is trained using a method of counts, directly based on observations using a method of updating by counts, which uses a computer program to add, for instance “+1” to a cell of the matrix that constitutes the factor. For instance, if a cell contains “0.4” (305), adding a count to the cell would mean raising the value of the cell to 1.4 (1+0.4). If the cell is part of a column that has three cells in total, which together form a distribution (e.g., 0.4, 0.2, 0.4,), then the column after the updated count would be “1.4; 2; 4”. The column gets renormalised such that its three cells sum to 1 (e.g., 1.4 becomes 0.7, 0.2 becomes 0.1, and 0.4 becomes 0.2). This method of adding counts trains the factor graph document database using observed data by adding +1 after observing the co occurrence b1 and a3, which augments the probability of P (b1|a3) in the factor graph to 0.7 and decreases the probability of the two other mapping of the collumn, bringing them down to 0.1 for P (b2|a3) and 0.2 for P (b3|a3).

The invention applies to a variety of documents and situations of document review. By way of example, an implementation of the present invention may apply to the review of a document containing the following text: “The cost of production was $1M in 2023”. Based on information previously stored, the factor graph document database contains, among other things, the following information: “The preferred food of the employees at the cafeteria in 2023 was lasagna”, and further includes information about the number of employees. A user requests a document review that would produce a summary for an audience that corresponds to the CEO office.

From a practical perspective, it will be appreciated that the database will be pre-populated with data of the particular entity. Thus, when we speak of different reports or extractions that are defined for the needs of a particular person, we are referring to the needs of different people within that entity, e.g., C-suite, or HR department, each of which will require reports geared toward their needs. Thus, the database captures the particular needs of the user querying it, that is, the audience needs. For instance, if the user is an employee of a company, the database should contain all the data of the company and the extracted reports geared towards the needs of the user based on all of the data that has been captured by the company (e.g., data about its employees, about its performance, about its clients, etc.).

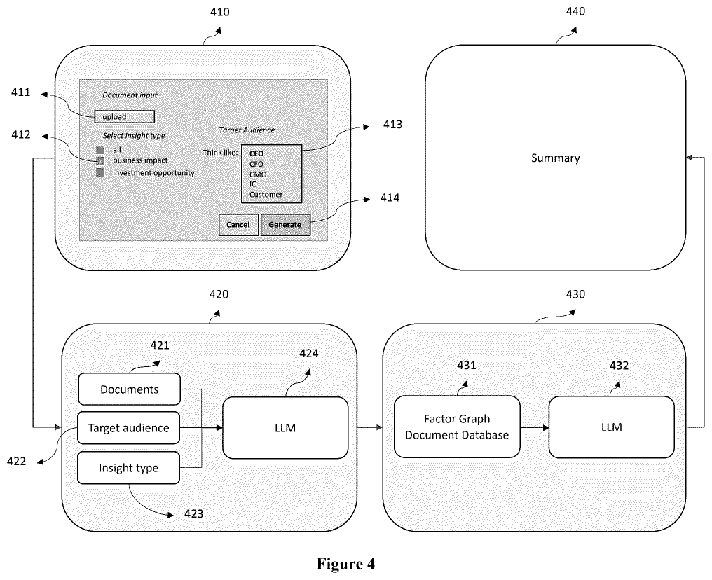

FIG. 4 presents a flowchart of the method of digital document review using factor graph document databases. A Graphical User Interface (GUI) (410) allows a user to select a document to review (411). The user further selects the type of insights she is looking for (412) (e.g., business impact), as well as the target audience to get the summary “in the voice of” a CEO (413), and then click on the “generate” button to generate the summary (414). The GUI communicates with an Application Programming Interface (API) using programming language that can access an LLM, which is designed to receive prompts and return response based on the data in the factor graph document database. The extract method (420) receives the document or series of documents (e.g., PDF, Audio, Video, etc.) (421), the target audience information (422) and the insight type information (423) specified by the user, and uses the information and document as input to an LLM (423) via the LLM Application Programming Interface (API) using programming language, along with the following prompts:

Prompt 1: “Treat this document as a knowledge graph by taking the noun subjects or pronoun subjects in the text as variable nodes with elements corresponding to quantities or qualities of these subjects such as presented in the text, and decompose this document into its parent and children variables with their elements”

Prompt 2: “Identify a list of new variables relevant to a CEO and relevant to a business impact summary based on the decomposed parent and children variables and elements”, where the terms “this document” refers to the document to be summarised, and where the terms “CEO” and “business impact” correspond to the insight type and target audience selected by the user. Prompt 1 is a static system prompt encoded as part of the program script of the extract method, which is passed to the LLM API, as is. Prompt 2 is a template system prompt with placeholders that are filled with the documents, target and insight types information once detected after having been submitted by the user.

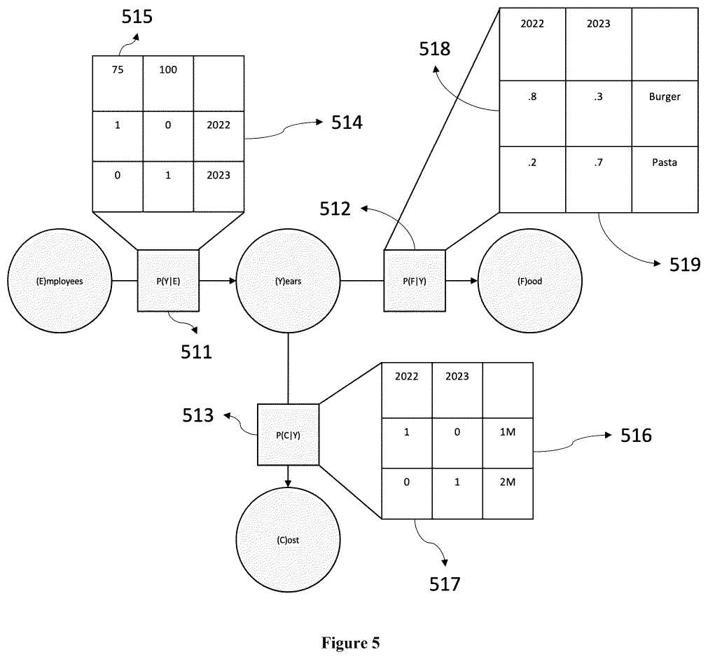

If the document under review is a PDF that contains a text such as “The cost of production was $1M in 2023”, the LLM will decompose the sentence into a variable “years” with the element “2023” and the variable “cost” with the element “1M”. These are stored in the factor graph document database in case they do not already exist as entities of the factor graph document database (421). The LLM also returns a list of terms that correspond to the audience description that will include terms such as “productivity”, “sick days”, etc., as well as terms that reflect the variables in the document under review, such as “cost”, “year”. The summarise method (430) uses the terms of the audience description to index the relevant factors of the factor graph document database (431), such as described in FIG. 5. The computational capacities of the factor graph document database are then used to infer additional information that may be relevant to the audience of the summary, based on the indexed factors (e.g., information that may be related to one of the terms such as the “number of employees” for the “year 2023”). The variables and elements decomposed from the document and the variables and elements inferred by the factor graph document database are then sent to an LLM to single out only the relevant ones based on the requested insight and audience (432) via an Application Programming Interface (API) to be reconstructed into a summary containing only information about relevant variables (440) in prose text. The factor graph document database infers variables and elements automatically using programming language upon the receipt of an element belonging to a destination node, as per the definition of destination nodes in FIGS. 1, 2 and 3 (e.g., the cost, year or food nodes in FIG. 5). Destination nodes function as input to a factor graph document database. The inference is performed using the inference algorithm described in reference numeral 306-309. The variables and elements are sent with the following prompts:

Prompt 3: “Write a summary out of this list of variables and elements”, where the term “this list” refers to the list of variables extracted from the document under review. The summary may be “The cost of production in 2023 was $1M, which included the cost of remuneration and training of the 75 employees of the company”.

The factor graph document database (FIG. 5) used to perform the inference in the summarise method is made of factors that relate variables and their elements with conditional probabilities, as per FIG. 3. As per FIG. 3, factor graph document databases are populated and trained by updating the counts in the matrices that encode the conditional probabilities of the entities represented along the column and the rows of the matrices. For instance, as per FIG. 3, if the database contains information about the relation between an entity “a” and “b” (e.g., the item “a” can be found at location “b”), the information concerning that relationship will be encoded probabilistically, for instance by attributing a X % probability that that relation is the case, and would be updated or trained by the method of adding counts described in the description of FIG. 3. The present invention does not concern the process of populating the factor graph document database; the information is already contained in the factor graph document databases to which this invention applies. The information deemed is that which matches the “target audience” and “insights” requested by the user, and is selected through a post inference step using an LLM (reference numeral 432). As illustrated below, the contribution of the factor graph document database to the invention is that it enables the inference of additional information related to the variables contained in the document submitted by the user, which is then parsed out for its relevance by an LLM, as per reference numeral 432. Although a distinct database is not necessary for each document under review, the insightfulness of the summary will depend on the extent to which the factor graph document database already contains relevant variables that can be found using the inference algorithm described in reference numeral 306-309.

The factor graph document database depicted in FIG. 5 includes a number of factors each defined by a matrix or tensor, in this case: a factor relating the number of “employees” E for each of the given “years” Y (P (Y|E)) (511), as well as a factor relating the cafeteria “food” F consumed by the employees for each year “years” Y (P(F|Y)) (512), and a factor that relates a variable “production cost” C with a variable “years” Y (P(C|Y)) (513). As discussed further below, the terms generated by the LLM based on the user's desired audience are used to index the factors of the factor graph database such that only the factors relevant to the audience will be computed to infer additional information (e.g., on 511 and 513), wherein indexing comprises identifying the cell (e.g., cell (2,1) below which is. 2) of interest in each matrix corresponding, for example with respect to variables Y and E:
Variable Y includes elements y1, y2, . . . yn and
Variable E includes elements e1, e2, . . . en
Factor: (P(Y|E))=[04. 06. 04; y1.
   0.2 0.3 0.6; y2.
   0.4 0.1 0] y3

The list of variables and elements produced by the LLM of the extract method, as per reference numeral 424 are those used as index for searching the factor graph document database, where the search is done using a programming language (e.g., by iterating through all the possible entity nodes, or variables of the factor graph and halting on the one corresponding to the ones being searched). The relevant nodes, or variables in the factor graph may be associated with other nodes, the inference over which will allow adding relevant information to the summary. For instance, as per our use case, the document under review is “The cost of production was $1M in 2023”, which only concerns “years” and “cost”, which are the variables searched in the factor graph document database. However, additional information may be related to years, such as the type of “food” consumed by the employees for ebay year. As in FIG. 3, the factors are matrices with rows and columns representing the conditional probability of the elements that are mapped in the cell. For instance, the factor with reference numeral 511 has “years” 2022 and 2023 on the rows (514), and has the number of “employees” 75 and 100 on the columns (515). In turn, the factor with reference numeral 513 has “costs” 1M and 2M on the rows (516), and has the “years” 2022 and 2023 on the columns (517), and the factor reference numeral 512 maps the probability of the food having been consumed at the cafeteria for each year. These conditional probabilities are used to perform the inference of the most probable variables for the audience of interest using the message passing algorithm described in FIG. 3. The inference using the algorithm described in reference numerals 306-309 for the whole graph would return the following statement: “In 2022, 80% (518) of the 75 employees had burgers and the production cost was $1M, and in 2023, 70% (519) of the employees had pasta and the cost of production was $2M”. The inferred statement above can be passed to the LLM of the summarise method reference numeral 432 along with the following prompt:

Prompt 4: “Make a business impact summary out of the following statement that would be relevant to a CEO”, where the statement corresponds to the inferred statement. The summary may be, for instance, “the cost of production increased by $1M between 2022 and 2023 along with the number of employees, which passed from 75 to 100”. As per prompt 2, prompt 4 is a template system prompt that is not written by a user, and that contains a placeholder filled, in this case, with the requested insight (e.g., business impact) and target audience (e.g., CEO). In case where the audience is, for instance, a member of the human resources, the summary may specify that “the cost of production increased by $1M between 2022 and 2023 along with the number of employees, which passed from 75 to 100 who have made healthier food choices, eating for the most part burgers in 2022 and pasta in 2023”.

What is claimed is:

1. A method of digital document review using a factor graph document database according to a summary of needs provided by a user, comprising,
receiving user input data, wherein the input data includes a document written in natural language that is to be reviewed, and further includes a summary of an audience's needs with respect to the document to be reviewed,
decomposing the text of the document to be reviewed according to the summary of the audience's needs into variables and elements for use in a factor graph document database, using a method of comparing data strings,
identifying new variables and elements relevant to the audience's needs that are semantically associated with the variables and elements decomposed from the text of the document to be reviewed, using a method of comparing data strings,
representing the relationship between all the variables, elements and factors in a factor graph document database, using a computer program,
inferring among the new variables those which are most probably related to the variables and elements representing the text of the document to be reviewed,
reconstructing a human interpretable document containing the variable, elements and factors according to the summary of needs and the most probable new variables, using a method of comparing data strings.

2. A method of claim 1, wherein the factor graph document database is made of one or more destination nodes representing variables over one or more elements, and of one or more source nodes representing variables over one or more elements, and of one or more edges capable of performing mathematical or logical operations over the elements of the variables represented by the destination nodes and the source nodes.

3. A method of claim 1, wherein the method of comparing data strings uses a Large Language Model and a series of engineered prompts.

4. A method of claim 2, wherein the inference over variables and elements of the factor graph document database is a message passing scheme using a sum-product algorithm for belief propagation that iterates over the factor graph document database, wherein the messages are propagated between adjacent source and destination nodes, and wherein each iteration updates the value of the variables and elements represented by the nodes until convergence is achieved.
